(19) United States
(12) Patent Application Publication
(10) Pub. No.: US 2012/0166411 A1
(43) Pub. Date: Jun. 28, 2012

(54) DISCOVERY OF REMOTELY EXECUTED APPLICATIONS

(75) Inventors: Matthew Bret MacLaurin, Woodinville, WA (US); George Moore, Covington, WA (US); Oscar E. Murillo, Redmond, WA (US); Benjamin William Vanik, Seattle, WA (US); Daniel Edward Walther, II, Redmond, WA (US)

(73) Assignee: MICROSOFT CORPORATION, Redmond, WA (US)

(21) Appl. No.: 12/978,662

(22) Filed: Dec. 27, 2010

(51) Int. Cl. G06F 17/30

(52) U.S. Cl. 707/706; 707/E17.108

(57) ABSTRACT

A search engine discovers and indexes applications in a search index and receives queries from devices. The search engine is configured to obtain contextual data describing context associated with the devices and/or social networking data associated with one or more users of the devices. Based upon the contextual data and/or the social networking data, the search engine modifies the query and executes the query to identify applications. The search engine generates search results corresponding to the identified applications. The search engine also is configured to generate advertising relevant to the modified query, and to rank the search results in accordance with the query, the contextual data, and/or the social networking data. The ranked search results and the advertising are presented to the client as search results and/or in a web store format. Activity of the client and the search engine can be tracked and reported to authorized entities.

### BACKGROUND

Native applications may include a number of functions and/or types of functions that the software or application developers bundle together due to their perceived usefulness or popularity. The native applications are often sold via online or physical storefronts. Users may purchase native applications online or in-person, and carry home or receive a disk or other medium that stores the applications or initiate a download of the applications from an online source. Once the applications are downloaded or received, the applications are installed on a computing device such as a computer, smart phone, or the like.

Web-based, cloud-based, and/or other remotely executed applications generally are not installed at a computing device in the same manner as native applications. Rather, the applications are typically accessed or executed via an installed native application such as a web browser for rendering and displaying application data and/or other content, or a runtime application that accesses data hosted at a web server or other location via a public or private application programming interface (“API”).

Remotely accessed applications generally must be explicitly searched for and/or discovered during other searches. While some vendors offer web-based and native versions of their applications, many do not. As such, identifying and making use of web-based, cloud-based, and/or remotely accessed applications may present many challenges, even for seasoned computer users.

It is with respect to these and other considerations that the disclosure made herein is presented.

### SUMMARY

Concepts and technologies are described herein for discovery of web-based, cloud-based, and/or remotely executed applications, and presentation of the applications. In accordance with the concepts and technologies disclosed herein, a search engine searches for and identifies applications. The search engine is configured to generate, categorize, and/or organize data describing the applications in a data storage device such as a memory, a server, or a database. The data describing the applications can be stored in searchable format, and can be made available to the search engine at any time. The search engine can provide search results that correspond to the identified applications, and provide the search results to searching entities in a search results page and/or in a web store format that provides an interface for purchasing, installing, accessing, and/or using the applications. Data associated with application usage can be tracked and used to improve search results and/or for other purposes. It should be understood that the search engine also can be configured to identify, categorize, search, present search results, and/or track data associated with sub-features of the applications. As used herein, the word “sub-feature,” and variants thereof, is used to refer to features of the applications, plug-ins for the applications, and/or groups or packages of features, plug-ins, groups of features, and the like.

According to one aspect, a client in communication with a search engine generates a query and submits the query to the search engine. The query is executed by the search engine to generate a query of a search index or other data storage device storing the data describing the applications. The search engine identifies one or more applications that satisfy or are relevant to the query and generates search results based upon the applications.

According to another aspect, the search engine is configured to obtain contextual data indicating activities at the client, activity history associated with the client, one or more operations occurring at the client, and the like. The search engine is configured to modify the query based upon the contextual data. The search engine also can obtain or access social networking data associated with a user of the client. The social networking data can be used in addition to, or instead of, the contextual data to modify the query based upon usage, comment, review, or rating by members of the user's social networks.

According to another aspect, applications are identified by the search engine and data identifying the applications or sub-features of the applications is presented to the client as search results. The search engine is configured to provide identifying information to the client such as hyperlinks and the like, as well as information describing the applications. The search engine also is configured to generate advertising for presentation with the search results, and to rank the search results based upon the query, the contextual data, and/or the social networking data. The ranking of the applications can be based upon popularity of the applications, usage of the applications, and other information.

According to another aspect, the search engine is configured to track activity of the search engine and/or the client, and to report the activity to authorized entities such as application developers. The data tracked by the search engine can relate to performance of the applications, times and days of usage of the applications, popularity of the applications, and/or other information. The data tracked by the search engine can be anonymized before being analyzed and/or provided to the authorized entities.

According to various embodiments, the client device is configured to execute a traditional operating system, and in other embodiments, the client device is configured to execute a web-based operating system. Thus, the client device may execute an operating system or other base program that is configured to access web-based or other remotely-executed applications and services to provide specific functionality at the client device. The client device therefore may provide various applications and services via a simple operating system or an application comparable to a standard web browser.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a system diagram illustrating an exemplary operating environment for the various embodiments disclosed herein.

FIG. 2 is a flow diagram showing aspects of a method for identifying and categorizing applications, according to an exemplary embodiment.

FIG. 3 is a flow diagram showing aspects of a method for searching for applications, according to an exemplary embodiment.

FIG. 4 is a flow diagram showing aspects of a method for tracking and reporting application metrics, according to an exemplary embodiment.

FIG. 5 is a computer architecture diagram illustrating an exemplary computer hardware and software architecture for a computing system capable of implementing aspects of the embodiments presented herein.

### DETAILED DESCRIPTION

The following detailed description is directed to concepts and technologies for discovery of remotely executed applications. According to the concepts and technologies described herein a search engine searches for, identifies, and indexes applications. According to various embodiments, the search engine indexes web-based, cloud-based, and/or other remotely accessed applications instead of, or in addition to, native applications. The search engine stores data describing the applications in a search index that is accessible to the search engine during execution of queries.

According to some implementations, the search engine receives a query from a client. The search engine is configured to determine if contextual data describing context associated with the client is available, and to receive the contextual data if available. The search engine also is configured to determine if social networking data associated with one or more users of the client is available, and to receive the social networking data if available. Based upon the query, the contextual data, and/or the social networking data, the search engine identifies one or more applications and generates search results corresponding to the identified applications. The search engine also is configured to generate advertising for presentation with the search results, and to rank the search results based upon the contextual data, the social networking data, and/or the terms of the query.

The search engine provides the search results to the client device with information for accessing the applications, and with the advertising determined by the search engine, if any. According to various embodiments, the search engine is configured to track usage, ranking, and advertising data and to generate application metrics based upon these data. The search engine provides the application metrics to authorized entities for use in addressing reliability, performance, advertising, ranking, and/or other concerns associated with the applications.

The word “application,” and variants thereof, is used herein to refer to computer-executable files for providing functionality to a user. According to various embodiments, the applications can be executed by a device, for example a computer, smartphone, or the like. Additionally, the computer, smartphone, or other device can execute a web browser or operating system that is configured to access remotely-executed applications and/or services such as web-based and/or other remotely-executed applications. In some embodiments, the applications are provided by a combination of remote and local execution, for example, by execution of JavaScript, DHTML, AJAX, .ASP, and the like. According to other embodiments, the applications include runtime applications built to access remote or local data. These runtime applications can be built using the SILVERLIGHT family of products from Microsoft Corporation in Redmond, Wash., the AIR and FLASH families of products from Adobe Systems Incorporated of San Jose, Calif., and/or other products and technologies. The applications also can include web applications.

For purposes of the specification and claims, the phrase “web application,” and variants thereof, is used to refer to applications that are configured to execute entirely or in-part on web servers and clients. Web applications can include multitier applications that include, but are not limited to, a data tier for storing and/or serving data used by the multitier applications, a logic tier for executing instructions to provide the functionality of the application, and a presentation tier for rendering and displaying the application output and/or interfaces for interacting with the applications. It should be understood that the names of the tiers provided herein are exemplary, and should not be construed as being limiting in any way.

While the description illustrates and describes applications, it should be understood that the concepts and technologies illustrated and described herein can be applied to sub-features of applications, as described above. As such, it should be understood that an application can be defined as an application and/or as a collection or group of one or more sub-features of the applications. For purposes of clarity, the description generally refers to applications, without explicitly stating sub-features, or the like. Thus, it should be understood that the applications described herein can include entire applications as well as one or more application sub-features as defined herein.

In some embodiments, servers, computers, and/or databases provide the functionality of the logic and data tiers, and generate application data that is provided to the presentation tier for rendering. In some implementations of web applications, a client provides the functionality associated with the presentation tier by rendering application data received from the logic and/or data tiers. In some implementations, the web applications can be packaged for offline use by the client and installed at the client. In these embodiments, the client can provide the functionality associated with the logic, data, and presentation tiers. It should again be noted that the word “application,” and variants thereof used herein includes, but is not limited to, the above definition of web applications.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and in which are shown by way of illustration specific embodiments or examples. Referring now to the drawings, in which like numerals represent like elements throughout the several figures, aspects of a computing system, computer-readable storage medium, and computer-implemented methodology for discovery of remotely executed applications will be presented.

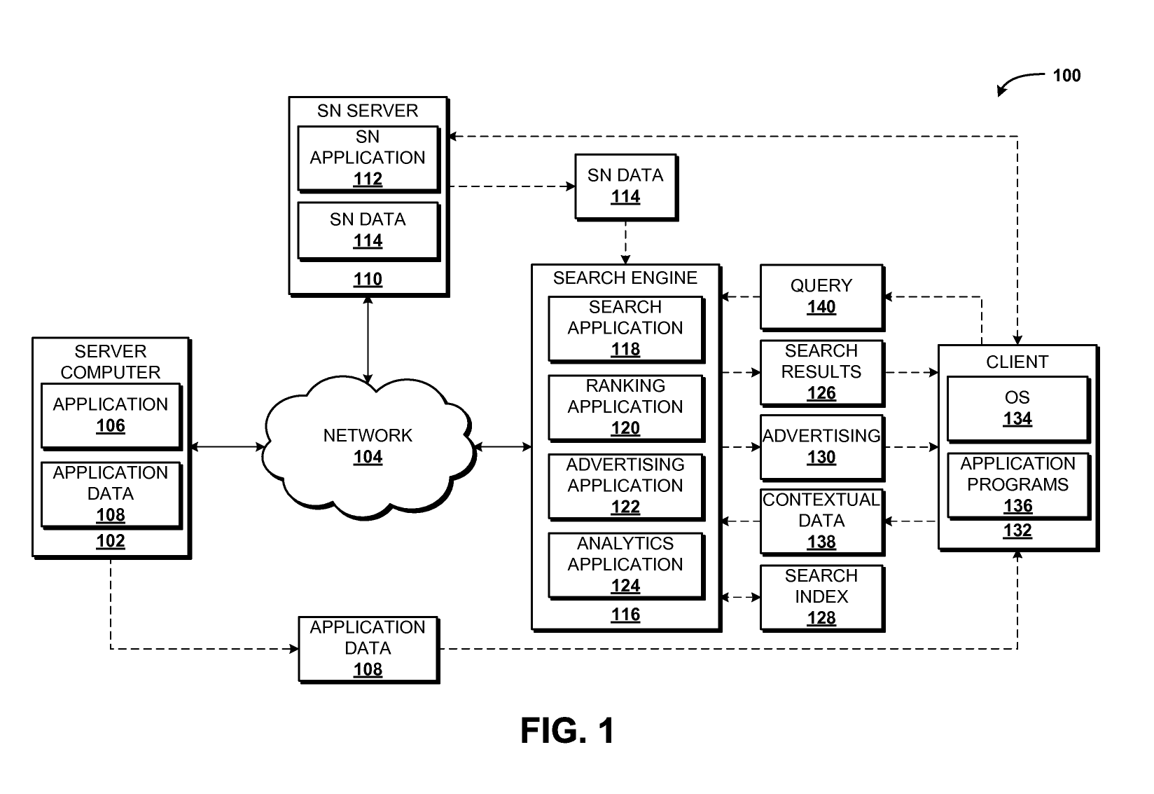

Referring now to FIG. 1, aspects of one operating environment 100 for the various embodiments presented herein will be described. The operating environment 100 shown in FIG. 1 includes a server computer 102 operating on or in communication with a network 104. According to various embodiments, the functionality of the server computer 102 is provided by a web server operating on or in communication with the Internet, though this is not necessarily the case.

The server computer 102 is configured to execute or store an application 106. In some embodiments, the application 106 is a server application executable by the server computer 102 to provide functionality associated with the server computer 102. In other embodiments, the server computer 102 stores the application 106 and allows other devices and/or network nodes to access, download, and/or modify the application 106. It therefore should be understood that the server computer 102 can include, but is not limited to, an application server and/or a data server.

In one exemplary embodiment, the application 106 is executable to provide a mapping application for providing maps, navigation instructions, location based services, and the like. The application 106 also can provide multimedia functionality such as, for example, video and audio streaming, video and audio playback functionality, and the like. The application 106 also can provide tools such as photo, video, and audio editing and creation applications, word processing functionality, data backup and storage functionality, calendaring applications, messaging applications such as email, text messaging, instant messaging, banking and financial applications, and realtime messaging applications, shopping applications, search applications, and the like. The above list is not exhaustive, as the application 106 can provide other types of functionality. Thus, the above examples are exemplary and should not be construed as being limiting in any way.

According to various embodiments, the application 106 is executed by the server computer 102. During execution of the application 106, the server computer 102 can generate application data 108. The application data 108 can include output associated with the application 106. As such, the application data 108 can include computer-executable instructions that, when rendered by a computer or other device, cause the computer or other device to display output associated with the application 106. Thus, the application 106 can be executed, and output associated with the application 106 can be rendered and displayed at a device remote from the server computer 102.

According to various embodiments, the operating environment 100 also includes a social networking server 110 (“SN server”) operating on or in communication with the network 104. The SN server 110 is configured to execute a social networking application 112 (“SN application”) to provide social networking services to one or more users. Exemplary social networking services include, but are not limited to, the FACEBOOK social networking service, the LINKEDIN professional networking service, the YAMMER office colleague networking service, and the like. In other embodiments, social networking functionality is provided by other services, sites, and/or providers that are not explicitly known as social networking providers. For example, some web sites allow users to interact with one another via email, chat services, gameplay, and/or other means, without explicitly supporting “social networking services.” Examples of such services include, but are not limited to, the WINDOWS LIVE service from Microsoft Corporation in Redmond, Wash., among others. Therefore, it should be appreciated that the above list of social networking services is not exhaustive, as numerous social networking services are not mentioned herein for the sake of brevity.

According to various embodiments, the SN application 112 generates social networking data 114 (“SN data”) associated with the social networking service and/or associated with one or more users of the SN application 112. Thus, the SN data 114 can describe, for example, social networking graphs associated with one or more users, communities and/or networks, user content such as status updates, photographs, reviews, links, videos, and the like, contact and biographical information associated with one or more users, and the like. The SN data 114 also can include, for example, information describing applications 106 accessed by users of the social networking service, links and status updates relating to applications 106 accessed by users of the social networking service, combinations thereof, and the like. For example, the SN data 114 can indicate whether one or more users has accessed the application 106, if desired. The SN data 114 also can include other information such as likes and dislikes associated with one or more users, comments associated with or generated by one or more users, connection requests associated by or generated by one or more users, and the like. It should be appreciated that the SN data 114 can include any type of social networking information, and that the provided examples are illustrative.

According to various embodiments, the operating environment 100 includes a search engine 116 operating on or in communication with the network 104. The functionality of the search engine 116 can be provided by one or more applications, which can be executed by one or more devices and/or combinations of devices. In some embodiments, the functionality of the search engine 116 is provided by one or more server computers configured to execute various applications, though this is not necessarily the case.

In the illustrated embodiment, the functionality of the search engine 116 is provided by a web server configured to execute a search application 118, a ranking application 120, an advertising application 122, an analytics application 124, and other applications (not illustrated). The other applications can include, for example, discovery applications for discovering and indexing applications 106, authentication applications for authenticating users with the search engine 116, billing and/or charging modules or applications for billing and/or charging for use of the search engine 116 and/or the applications 106, and other applications and/or modules.

Although the search application 118, the ranking application 120, the advertising application 122, and the analytics application 124 are illustrated as components of the search engine 116, it should be understood that each of these components, or combinations thereof, may be embodied as or in stand-alone devices or components thereof operating on or in communication with the network 104. Thus, the illustrated embodiment is exemplary, and should not be construed as being limiting in any way.

The search application 118 is configured to provide search functionality for the search engine 116. For example, the search application 118 can provide functionality for receiving, parsing, interpreting, and executing search queries or other requests. The search application 118 is configured to identify one or more documents, files, applications 106, and/or other resources, some, all, or none of which can be presented to a searcher or other entity as search results 126. The search results 126 can be passed to the searcher or other entity via a search result page, links to the documents, files, applications 106, and/or other resources, and the like, as is generally known. In some embodiments, the search results 126 correspond to the applications 106 and are presented in a web store format via which the applications 106 can be accessed and/or purchased. Thus, the search results 126 can include data for displaying information relating to the applications 106 in a web store interface. Thus, the search results 126 can include descriptions of the applications 106, prices associated with one or more versions and/or features of the applications 106, ratings or reviews associated with the applications 106, and the like. These and other data can be rendered or displayed by a device viewing or accessing the search results 126 and/or a web store presenting the search results 126. These and other embodiments for presenting the search results 126 are described in more detail herein.

The search results 126 can identify applications 106, and can identify the applications 106 by one or more addresses, names, categories, functionality descriptions, and the like. In some embodiments, the locations of applications 106 are identified by one or more uniform resource locator (“URL”) addresses associated with the applications 106. Other methods of identifying the location of applications 106 or other resources on a network are known and will not be described herein for the sake of brevity.

The search application 118 also is configured to provide discovery functionality for the search engine 116. According to various embodiments, the search application 118 is configured to discover the applications 106, and to store data describing the applications 106. More particularly, the search application 118 can identify the applications 106 as well as functionality associated with the applications 106. According to various embodiments, the applications 106 can be configured to self-declare the functionality of the applications 106. For example, the applications 106 can include computer executable instructions that, when executed by the server computer 102, cause the server computer 102 to self-describe the applications 106 and provide or make available data describing the applications 106 and/or functionality thereof. In other embodiments, the search application 118 is configured to identify the applications 106 during a search or network crawl, and to generate data describing functionality associated with the application 106.

In some embodiments, the search application 118 is further configured to organize and categorize the data describing the applications 106 and/or functionality thereof. The data describing the applications 106 can be catalogued, categorized, organized, and stored in a search index 128. The functionality of the search index 128 can be provided by one or more data storage devices such as, for example, one or more databases, server computers, mass storage devices, memory devices, combinations thereof, and the like.

In addition to, or instead of, the search application 118 identifying, categorizing, and/or organizing the data describing the applications 106, application developers can be allowed or required to package and submit applications 106 to the search engine 116 and/or another device for indexing, categorizing, organizing, and the like. In some embodiments, the developers author descriptions and/or metadata describing the functionality of the applications 106, the types of inputs accepted by the applications 106, the types of outputs generated by the applications 106, keywords or tags associated with the applications 106, limitations and/or capabilities of the applications 106, combinations thereof, and the like.

The ranking application 120 is configured to provide ranking of the search results 126 identified by the search application 118 before, during, or after the search results 126 are provided to the searcher or other entity. According to various embodiments, the ranking application 120 ranks the search results 126 based upon anticipated relevance of the search results 126 to the searcher or other entity and/or based upon other considerations. The search results 126 also may be ranked according to performance metrics, user ratings, and/or other information associated with the applications 106. For example, the search results 126 may be ranked based upon power consumption associated with the applications 106, which may correspond to power consumed by processors, computers, and/or servers executing the applications 106. The search results also may be ranked based upon a number or frequency of downloads or accesses associated with the applications 106, user ratings or reviews associated with the applications 106, developer ratings and reviews, and the like. The search results 126 also may be ranked based upon trends associated with the applications 106. For example, the ranking of the search results 126 can be increased due to a trending upward popularity associated with one or more applications 106 associated with the search results 126. Similarly, rankings of search results 126 can be reduced based upon negatively trending reviews, ratings, comments, and the like, associated with the applications 106 that correspond to the search results 126. These examples are illustrative, and should not be construed as being limiting in any way. Furthermore, it should be noted that any combination of the above and/or alternative ranking methods may be used, depending upon user or operating needs and/or preferences.

The search results 126 may be ranked, at least in part, based upon one or more ranking or advertising schemes. In some embodiments, application developers may pay to increase the rank of search results 126 corresponding to applications 106 authored by or associated with the application developers. In other embodiments, entities may pay a fee or otherwise participate in programs to modify the ranking of the search results 126. For example, the placement of particular applications 106 and/or search results 126 relating to the applications 106 may be improved in a search results page, a web store interface, or other presentation interface. For purposes of this application, “improving” placement of a search result 126 includes shifting the location of the search result 126 to move the search result 126 to a location at which there is an increased likelihood that the search result 126 will be viewed or selected. If the search results 126 are presented in a list, for example, an improved placement of the search result 126 can include shifting the search result 126 to the top of the list of search results 126. These and other approaches for improving the placement and/or ranking of search results 126 can be managed and administered by the ranking application 118. These examples are illustrative, and should not be construed as being limiting in any way.

The advertising application 120 is configured to generate advertising 130 to present with, or embed in, the search results 126, and to manage the positioning and presentation of the advertising 130. In some embodiments, the advertising application 120 manages subscriptions and/or advertising campaigns for application developers and/or other entities (“advertisers”). For example, advertisers can pay a fee or otherwise participate in advertising services designed to select and present advertising 130 and/or to enhance or improve the presentation of search results 126 in accordance with a marketing plan. For example, a screenshot or icon relating to the search results 126 can be included in a list of search results 126, if desired, which may increase the likelihood that a searcher will click on the search result 126. Additionally, or alternatively, text or images relating to particular search results 126 can be decorated with tags, widgets, highlighted with colors that draw attention to the search results 126, placed into banner ads, and/or otherwise placed in static and/or prominent positions on search results pages or online stores and the like.

Additionally, the advertising application 120 can access and/or manage a repository of advertising 130 such as images, text, widgets, video, audio, and the like. Based upon searches and/or other activity sensed by the search engine 116, the advertising application 120 can be relied upon to select, generate, and/or present relevant advertising. Furthermore, the advertising application 120 can be used to generate and present advertising 130 during access or execution of the application 106, if desired. These and other approaches to selecting and presenting advertising 130 can be managed and applied to search results 126 or applications 106 by the advertising application 120. It should be understood that the above examples are illustrative, and should not be construed as being limiting in any way.

It should be understood that the ranking and placement of the search results 126, and the selection and placing of advertising 130 can be related and/or may be part of a unified marketing campaign. As such, in some embodiments, the ranking application 118 and the advertising application 120 work in unison to rank and position the search results 126 and to select and position the advertising 130 in accordance with a marketing plan.

The analytics application 124 is configured to track application metrics and to report the application metrics to one or more entities. The application metrics can include, for example, search information relating to the applications 106, ranking information relating to the applications 106, and advertising information relating to the applications 106. The application metrics also can include data indicating usage of the applications 106, performance of the applications 106, and information indicating how the application 106 behaves. According to various embodiments, users can activate or deactivate the functionality of the analytics application 124 to address perceived privacy and/or security concerns.

If a user opts-in to the metrics tracking functionality of the analytics application 124, the analytics application 124 can track usage of the applications 106 and/or other activity such as searches, queries, shopping, logins, social networking services, and the like. All of this information can be stored and/or analyzed by the analytics application 124, anonymized by the analytics application 124, and reported to an entity such as an application developer associated with one or more of the applications 106. Thus, application developers or other authorized entities can have access to various information relating to usage and access of the applications 106. Exemplary information that may be tracked by the analytics application 124 includes data indicating what types of users access the applications 106, how the applications 106 are used, the types of searches or other activity that led to use of the applications 106, the time of day, day of week, month of the year, and the like that the applications 106 are used, search histories associated with users of the applications 106, the number of repeat uses of the applications 106, locations of users or devices accessing or using the applications 106, languages of users of the applications 106, duration of usage of the applications 106, versions of the applications 106 used or accessed by users, other information, and the like. These examples are illustrative, and should not be construed as being limiting in any way.

According to various embodiments, the operating environment 100 further includes a client 132. The client 132 can include a personal computer (“PC”) such as a desktop, tablet, or laptop computer system. The client 132 may include other types of computing systems including, but not limited to, server computers, handheld computers, netbook computers, embedded computer systems, personal digital assistants, mobile telephones, smart phones, or other computing devices. Although not illustrated in FIG. 1, it should be understood that the client 132 can communicate with the search engine 116 via the network 104.

The client 132 is configured to execute an operating system 134. According to various embodiments, the operating system 134 executed by the client 132 is a traditional operating system such as the WINDOWS family of operating systems from Microsoft Corporation of Redmond, Wash. and/or a web-based operating system. Thus, it will be understood that according to various embodiments, the client 132 is configured or equipped to execute traditional native applications and/or programs at the client-side and/or to access the applications 106, which can include remotely-executed applications such as web applications and/or other remote applications. The client 132 can receive the application data 108, which can be rendered by the operating system 134 or an application program 136 executed by the client 132. In still other embodiments, the client 132 is configured to access remotely-executed applications and to execute some local code such as scripts, local searches, and the like. As such, the client 132 can be configured to access or utilize cloud-based, web-based, and/or other remotely executed applications, and to render the application data 108 relating to those applications at the client 132.

In some embodiments, the application programs 136 executed by the client 132 include a web browser or stand-alone application for accessing web-based or runtime applications, and to render the data generated by the web-based or runtime applications for use at the client 132. Thus, the application programs 136 can include one or more programs for accessing and rendering web pages, accessing and rendering applications, and/or accessing and rendering services. In some embodiments, the application programs 136 also include stand-alone or runtime applications that are configured to access web-based or remote resources and/or applications via public or private application programming interfaces (“APIs”) and/or public or private network connections. Therefore, the word “application” and variants thereof should be understood as including locally-executed applications, remotely-executed applications, and/or applications that execute locally-in-part and remotely-in-part.

According to some embodiments, the search engine 116 is configured to receive or retrieve contextual data 138 associated with the client 132. The contextual data 138 can describe contextual information associated with the client 132. The contextual information may indicate, for example, one or more remote or local applications 106 being accessed or executed by the client 132. The contextual data 138 can be generated by the client 132 and received or retrieved by the search engine 116. Additionally, or alternatively, the search engine 116 can be authorized to access the client 132 and to generate the contextual data 138 based upon one or more activities occurring at the client 132.

In addition to determining what kind of activities are occurring at the client 132, the contextual data 138 can indicate activity associated with the client 132 over some time period, for example, during the day, the previous week, the previous month, and the like. The contextual data 138 can relate to some or all interactions at the client 132 including web searches, application 106 usage, email messaging usage, map usage, and the like.

The contextual data 138 also can describe one or more actions taken entirely at the client 132. For example, the contextual data 138 may indicate movement of a cursor or pointer at the client 132, alphanumeric text input received at the client 132, clicking at a particular location or region at the client 132, and/or other movements or inputs received at the client 132. These and other inputs can prompt, for example, local execution of scripts and/or code at the client 132. These actions can be captured by the contextual data 138 and passed to the search engine 116. These and other actions can be mediated by an application executed remotely or locally relative to the client 132, and therefore may be captured by the contextual data 138 not only as particular actions, but additionally, or alternatively, as specific invocation of particular functionality associated with the remote or local application, script, or code execution.

The contextual data 138 can be used by the search engine 116 during searching and/or during ranking, advertising, and/or presenting of the search results 126 and/or the advertising 130 generated during the search. In some embodiments, the search application 118 uses the contextual data 138 during search functions to identify applications 106 and/or other resources that are relevant to the client 132 based upon the contextual data 138. The search application 118 can include search terms or limitations based upon the contextual data 138, which may improve the relevancy of the search results 126. In an exemplary embodiment, the contextual data 138 indicates that the client 132 is accessing a local or remote audio file. Based upon the contextual data 138, the search application 118 may modify searches or queries to identify applications 106 related to audio files. This example is illustrative, and should not be construed as being limiting in any way.

In some embodiments, the search application 118 receives or retrieves the SN data 114 in addition to, or instead of, the contextual data 138. The search application 118 can use the SN data 114 to identify applications 106 used, consumed, reviewed, posted, commented on, or otherwise referenced by one or more members of a social network associated with a particular user, for example, a user associated with the client 132. Thus, the search application 118 can modify searches or queries based upon one or more of the contextual data 138 associated with the client 132 and/or one or more social networks corresponding to a user of the client 132.

According to various embodiments, the search engine 116 identifies applications 106 and stores categorized and/or otherwise organized data describing the applications 106 at the search index 128. The search engine 116 receives a search query 140 from the client 132 or another entity. The search engine 116 executes the query 140 and queries the search index 128 to identify one or more applications 106 that satisfy the received query 140. The search engine 116 also can identify one or more suggestions corresponding to applications 106 that may or may not satisfy the query 140, but nonetheless are believed to be relevant or pertinent to the searcher. The identified applications 106 can be ranked by the ranking application 120, and advertising 130 can be generated by the advertising application 122.

The search application 118 outputs data identifying the applications 106 as the search results 126, which can be output with advertising 130, if desired. The search results 126 are provided to the client 132 and/or another device. The ranking of the search results 126, as well as the advertising 130 provided with the search results 126, are tracked by the analytics application 124. This information can be reported to one or more entities and/or used to affect the perceived relevance of applications 106 to particular search queries, to rank the search results 126, and/or to generate advertising 130. The ranked search results 126 are provided to the client 132.

The client 132 can receive input from a user of the client 132, for example, a click on one of the search results 126 and/or advertising 130. This input also is tracked by the analytics application 124, anonymized by the analytics application 130, and reported to one or more entities. If the input from the client 132 corresponds to a click on a search result 126 and/or advertising 130 corresponding to a link to an application 106, the client 132 can access the application 106. Application data 108 associated with the application 106 can be accessed by the client 132, for example the application 106 can be accessed or remotely executed, and the application data 108 can be transmitted to or retrieved by the client 132.

FIG. 1 illustrates one server computer 102, one network 104, one SN server 110, one search engine 116, one search index 128, and one client 132. It should be understood, however, that some implementations of the operating environment 100 include multiple server computers 102, multiple networks 104, multiple SN servers 110, multiple search engines 116, multiple search indexes 128, and/or multiple clients 132. Thus, the illustrated embodiments should be understood as being exemplary, and should not be construed as being limiting in any way.

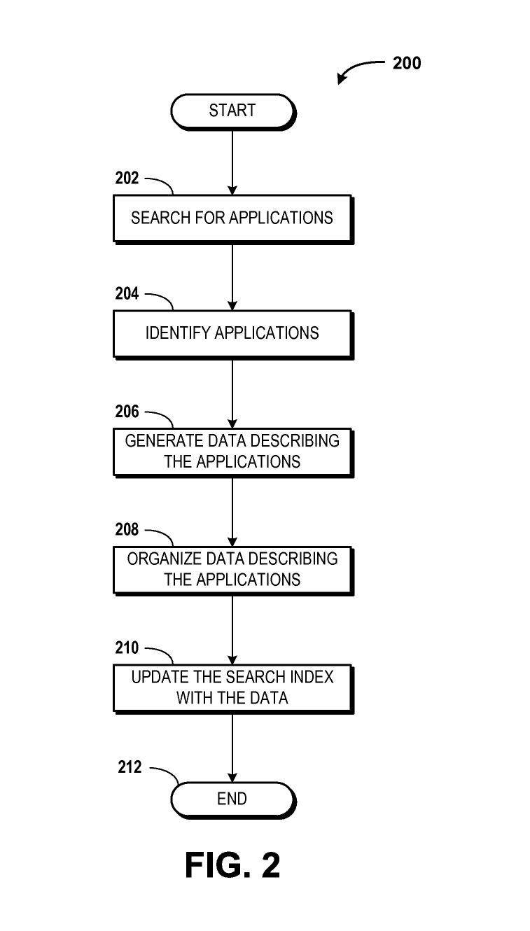

Turning now to FIG. 2, aspects of a method 200 for identifying and categorizing applications 106 will be described in detail. It should be understood that the operations of the methods disclosed herein are not necessarily presented in any particular order and that performance of some or all of the operations in an alternative order(s) is possible and is contemplated. The operations have been presented in the demonstrated order for ease of description and illustration, and not for purposes of limiting the disclosure in any way. Operations may be added, omitted, and/or performed simultaneously, without departing from the scope of the appended claims.

It also should be understood that the illustrated methods can be ended at any time and need not be performed in their respective entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof.

For purposes of illustrating and describing the concepts of the present disclosure, the method 200 is described as being performed by the search engine 116 via execution of one or more applications such as, for example, the applications 118, 120, 122, 124. It should be understood that this embodiment is exemplary and should not be viewed as being limiting in any way. In particular, one or more additional or alternative devices can execute these and/or other applications without departing from the scope of the disclosure.

The method 200 begins at operation 202, wherein the search engine 116 searches for applications 106. According to various embodiments, the search engine 116 performs periodic searches of devices and software communicating with the network 104 to identify applications 106 accessible via the network 104. In other embodiments, the devices and software communicating with the network 104 periodically generate data describing applications 106 accessible via the network 104 and transmit the data to the search engine 116. In still other embodiments, data describing the applications 106 accessible via the network 104 is provided by application developers and submitted to the search engine 116 with information identifying the applications 106.

From operation 202, the method 200 proceeds to operation 204, wherein the search engine 116 identifies one or more applications 106. As mentioned above, the search engine 116 can identify the applications 106 during a search or web crawl. Additionally, or alternatively, an entity may submit information identifying the applications 106 to the search engine 116 via a form or other user interface, email, and/or other means. In some embodiments, the applications 106 are web applications and/or are written in one or more web-based languages and/or formats such as HTML, XHTML, JavaScript, DHTML, AJAX, and the like. The applications 106 can be decorated with extensibility tags, META tags, and/or other tags or text. In some embodiments, the search engine 116 identifies the applications 106, at least in part, by recognizing these and/or other tags or text. It should be understood that these embodiments are exemplary, and that the applications 106 can be identified in other ways.

From operation 204, the method 200 proceeds to operation 206, wherein the search engine 116 determines application characteristics and generates data describing the applications 106. The data describing the applications 106 can include, for example, descriptions of functionality associated with the application 106 and/or one or more network locations associated with the application 106, for example, one or more URLs identifying the location of the applications 106. The data describing the applications 106 also can include computing requirements, registration information and/or requirements, application 106 version numbers, availability information, capacity or file size limitations and/or requirements, combinations thereof, and the like.

As mentioned above, in some embodiments, the applications 106 are web applications and can be decorated with extensibility tags, META tags, and/or other tags and/or text. In some embodiments, the search engine 116 generates the data describing the applications 106 based, at least in part, these and/or other tags and/or text. The data describing the applications 106 can indicate how the applications 106 are called, inputs required for the applications 106, outputs generated by the applications 106, computing, bandwidth, and/or networking requirements for accessing or executing the applications 106 and/or rendering the application data 108, availability information for the applications 106, combinations thereof, and the like. The data describing the applications 106 also can indicate other applications 106, services, and/or resources that are invoked by access and/or execution of the applications 106. Because the data describing the applications 106 can include almost any information relating to or describing the applications 106, it should be understood that the above examples of the data are illustrative, and should not be construed as being limiting in any way.

From operation 206, the method 200 proceeds to operation 208, wherein the search engine 116 organizes the data describing the applications 106. The search engine 116 can organize the data describing the applications 106 according to any desired aspects of the data. In some embodiments, for example, the data describing the applications 106 is categorized and/or organized based upon functionality associated with the applications 106. For example, data describing multimedia applications 106 can be stored in one category of data dedicated to multimedia applications 106. Similarly, the multimedia applications can be organized into a number of subcategories or other divisions based upon a type of multimedia, a type of applications, and the like, such as music applications, video applications, slideshow applications, playback applications, recording applications, editing applications, and the like. These examples should be understood as being illustrative, and should not be construed as being limiting in any way.

The categories and/or subcategories of the data describing the applications 106 can be based upon broad or narrow definitions. For example, the data describing the applications 106 can be organized into an audio processing applications category, which may be considered a narrow category relative to an audio application category and/or a multimedia application category. It therefore should be understood that the data can be organized into any number of categories, subcategories, and/or other divisions, based upon desires, needs, and/or preferences. For example, the data describing the applications 106 can be organized or categorized in one or more ways. For example, data describing a particular application 106 may be organized or categorized based upon functionality of the application 106, as well as bandwidth requirements for the application 106, cost of the application 106, authorship associated with the application 106, reviews, rankings, and/or ratings associated with the application 106, and/or other characteristics. Thus, the examples provided herein should be understood as being illustrative, and should not be construed as being limiting in any way.

From operation 208, the method 200 proceeds to operation 210, wherein the search engine 116 updates the search index 128 with the organized data describing the applications 106. According to various implementations, the search engine 116 can store the organized data describing the applications 106 by adding the data to the search index 128 and/or can update the data in the search index 128 to merge the data describing the applications 106 with the data stored in the search index 128. In some embodiments, the search index 128 is hosted by an index server (not illustrated) that is configured to serve data from the search index 128 to the search engine 116. In still other embodiments, the search index 128 is stored in a memory device associated with the search engine 116. The method 200 ends at operation 212.

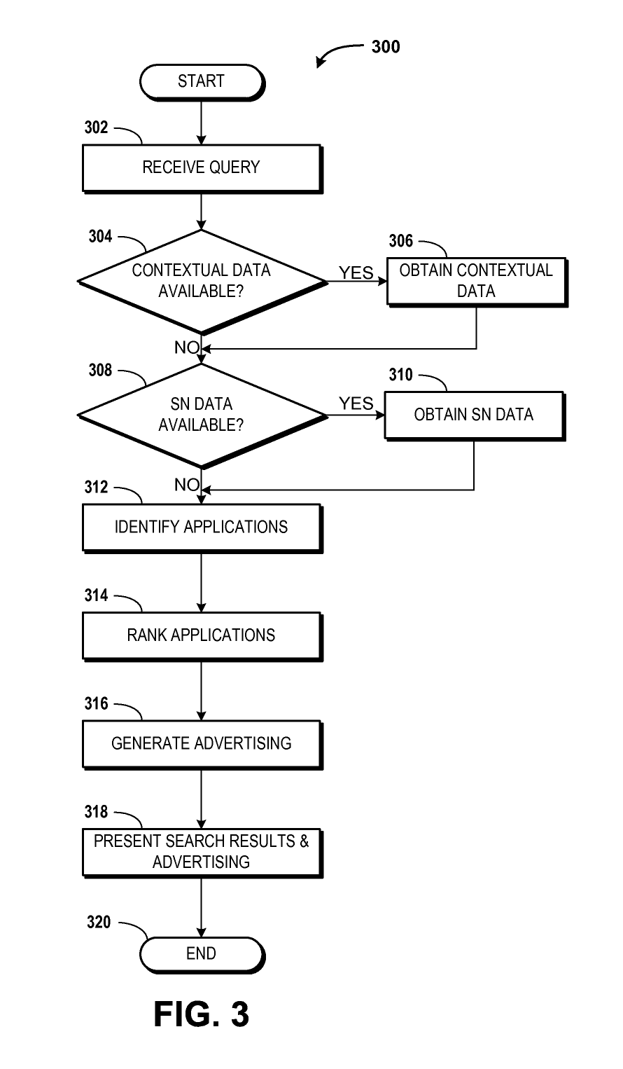

Turning now to FIG. 3, a method 300 for searching for applications 106 is described in detail, according to an exemplary embodiment. For purposes of illustration, and not limitation, the method 300 is described as being performed by the search engine 116. It should be understood that this embodiment is exemplary, and should not be construed as being limiting in any way.

The method 300 begins at operation 302, wherein the search engine 116 receives a query 140. In the described embodiment, the query 140 received by the search engine 116 is associated with the client 132, though this is not necessarily the case. For example, the client 132 can submit the query 140 to the search engine 116 via a web browser or other application program 136 executing at the client 132 and/or via the OS 134, as is generally known.

From operation 302, the method 300 proceeds to operation 304, wherein the search engine 116 determines if contextual data 138 associated with the client 132 is available. The contextual data 138 describes interactions occurring at the client 132 and/or a usage history associated with the client 132. For example, the contextual data 138 may describe files, resources, and/or applications 106 accessed or utilized by the client 132, operations occurring at the client 132, and the like. Additionally, or alternatively, the contextual data 138 can describe historical usage information associated with the client 132 such as search histories, application 106 access histories, usage times, and the like. Thus, the contextual data 138 describes interactions occurring at the client 132 and/or interactions that have occurred at the client 132. If the search engine 116 determines that the contextual data 138 is available, the method 300 proceeds to operation 306, wherein the search engine 116 obtains the contextual data 138.

From operation 306, or if the search engine 116 determines in operation 304 that the contextual data 138 is not available, the method 300 proceeds to operation 308, wherein the search engine 116 determines if SN data 114 is available. Although not illustrated in FIG. 3, it should be understood that the operation 306 can include identifying an entity associated with the query 140, disambiguating the identification of the entity, and determining if the SN data 114 is available for the identified and disambiguated user.

According to some embodiments, the client 132 executes a login procedure or sequence upon startup and/or when using a browser or other application program 136 that makes use of the search engine 116. According to one implementation, the client 132 is configured to authenticate with and login to the search engine 116 upon startup. As such, all activity occurring between the client 132 and the search engine 116 can be associated with the client 132. As such, the search engine 116 may not need to disambiguate the user of the client 132, as that information may be known due to the login/authentication procedures set forth above. It should be appreciated that other methods can be used to associate activity with a particular user or client 132. For example, cookies or device identifiers may be used instead of, or in addition to, logins or other authentication methods to associate activity with a particular user or device. Similarly, some unique identifier can be associated with the client 132 and communicated to the search engine 116 without requiring any input from the user. As such, the illustrated embodiments should be understood as being illustrative.

In yet other embodiments, the client 132 executes a web-based OS that provides web-based and/or other remotely accessed applications 106. In some embodiments of the web-based OS, the client 132 accesses the applications 106 via the search engine 116 and/or a module or application executed thereby. In some implementations of the web-based OS, a user logs into and/or authenticates with the client 132 upon startup, and the client 132 makes identity information available to authorized applications 106 and/or authorized search platforms such as the search engine 116. As such, though not illustrated in FIG. 1, it should be understood that the search engine 116 and/or the client 132 can include authentication and/or login modules or applications for authenticating and/or allowing login by users of the client 132.

If the search engine 116 determines in operation 308 that the SN data 114 is available, the method 300 proceeds to operation 310, wherein the search engine 116 obtains the SN data 114 from the SN server 110. It should be understood that the SN data 114 can relate to two or more social networks. As such, the operation 310 can include obtaining SN data 114 from one or more SN servers 110. Furthermore, as mentioned above, the SN data 114 can be obtained from other sources that do not explicitly offer social networking services, but offer services that resemble or incorporate certain aspects typically associated with social networking services such as chatting, status updates, link posting, and the like. Thus, it should be understood that the search engine 116 can obtain the SN data 114 from any desired sources.

As mentioned above, the SN data 114 can include data indicating one or more members of one or more social networks, one or more connections associated with a user of the client 132, as well as other data corresponding to the social networks. According to an exemplary embodiment, the SN data 114 corresponds to one or more social networks associated with a user of the client 132. The SN data 114 can indicate not only members of the social network associated with the user, but also comments, multimedia content, links, photographs, status updates, reviews, ratings, likes and dislikes, applications 106, biographic information, and the like, associated with the members of the social networks. According to various embodiments, the SN data 114 indicates applications 106 used, accessed, or authored by one or more members of a social network associated with the user of the client 132.

The SN data 114 can be used by the search engine 116 to search for applications 106 that are expected to be of interest to the user of the client 132, in light of the SN data 114. For example, the search engine 116 can determine, based upon the SN data 114, that a social network connection associated with a user of the client 132 has used or accessed a particular application 106. On the basis of this usage or access, the search engine 116 can infer that the user of the client 132 will be interested in using or accessing the same or a similar application 106. In some embodiments, ratings or reviews of the applications 106 can be used to identify applications 106 that members of a user's social network have enjoyed or found useful, an indication that can be used by the search engine 116 to include, exclude, and/or affect the rank of the application 106 in the search results 126. These and other types of SN data 114 can be obtained, accessed, downloaded, and/or used by the search engine 116.

From operation 310, or if the search engine 116 determines in operation 308 that the SN data 114 is not available, the method 300 proceeds to operation 312, wherein the search engine 116 identifies one or more applications 106 that satisfy the query 140. The search engine 116 searches or queries the search index 128 based upon the query 140, which can be supplemented and/or modified by the search engine 116 to include neither, one, or both of the contextual data 138 and/or the SN data 114, depending upon the availability thereof as determined in operations 304 and 308.

In some embodiments, the search engine 116 identifies the applications 106 by searching through the data in the search index 128 to identify applications that satisfy terms in the query 140. For example, if a search query 140 includes “free audio playback application,” the search engine 116 can query the search index 128 to identify applications 106 that are free, designed to access audio files, and configured to provide playback functionality. The search engine 116 can generate search results 126 for the query 140 wherein the search results 126 satisfy some, all, or none of the terms of the query 140. In the event that the search engine 116 does not identify any applications 106 that fully satisfy the query 140, the search engine 116 can present search results 126 that satisfy some terms of the query 140 and/or that are expected to be relevant to the query 140, if such applications 106 exist. To provide this functionality, the search engine 116 can be configured to perform natural language processing and parsing of the query 140 to identify search terms and/or a hierarchy for applying the identified terms.

In some implementations, the search engine 116 modifies the query 140 and/or the search results 126 based upon the contextual data 138. Thus, implicit information corresponding to the contextual data 138 can be included in the query 140 to improve the results of the query 140. In one exemplary embodiment, the client 132 is using a photo editing application to view a photograph. The search engine 116 receives a query 140 from the client 132 for “red eye.” Under certain circumstances, execution of this query 140 by the search engine 116 may yield results for early morning flights and/or eye drops. Given the context of photograph viewing, which may be provided in the contextual data 138, the search engine 116 can supplement the search terms with terms such as “photograph,” “removal,” “editing,” and the like, or by identifying applications 106 that are configured to edit file types corresponding to the photograph being displayed at the client 132. As will be appreciated from the disclosure herein, the search engine 116 in this example also can identify red-eye removal plug-ins or other types of sub-features of the applications 106 and provide links or other results relating those sub-features in addition to, or instead of, entire applications as authored by application developers. This example is merely illustrative of how the search engine 116 can supplement searches based upon the contextual data 138, and should not be construed as being limiting in any way. Furthermore, it should be understood that while the example describes narrowing a query 140 based upon the contextual data 138, that the contextual data 138 also can be used to broaden the search, if appropriate.

Similarly, the search engine 116 can use the SN data 114 to modify the query 140 by adding terms to the query 140 and/or by removing or substituting terms in the query 140. For example, the search engine can use the SN data 114 to search for tasks that are expected to be of interest to the user of the client 132 based upon opinions, usage, and/or comments of users of the user's social network. If, for example, a query 140 includes the phrase “red eye removal,” the search engine 116 may access the SN data 114 to determine if connections of the user of the client 132 have used particular photo editing applications. If a particular application is popular among the members of the user's social network, the search engine 116 may assume that the user of the client 132 likewise will enjoy, like, or find useful the application 106. Similarly, the search engine 116 can inform a user of the client 132 that a social network connection has used a particular application 106 and suggest the application 106 to the user of the client 132.

It should be understood that the search engine 116 can make a number of inferences based upon the contextual data 138 and the SN data 114 and/or make suggestions or modify the search results 126 based upon the contextual data 138 and the SN data 114. In the above example of a search for “red eye,” wherein the above examples of contextual data 138 and SN data 114 are exist, the search engine may modify the query 140 from “red eye” to include photograph editing applications that are used, liked, or rated highly by connections associated with the user of the client 132. It should be understood that the above examples of the contextual data 138 and the SN data 114 are exemplary, and should not be construed as being limiting in any way.

From operation 312, the method 300 proceeds to operation 314, wherein the search engine 116 ranks the search results 126. The search engine 116 can base ranking of the applications 106 upon one or more of the contextual data 138 and the SN data 114, as well as other factors. Additionally, the search engine 116 can determine how to rank the applications 106 based upon usage of the applications 106 by other users. For example, the search engine 116, can monitor usage of the applications 106 over time, and can store data in the search index 128, the data indicating not only descriptive information for describing functionality of the applications 106, but also statistics or other information indicating usage of the applications 106, searching or application-usage activity before and after the applications 106 are used, numbers of uses of the applications 106, and other information.

Additionally, the ranking of the applications 106 can be based upon other considerations. For example, entities or companies may pay to have specific applications 106 listed first or at an elevated level in the search results 126 for searches related to the applications 106. For example, a company may pay a fee to have a video playback application listed at or near the top of search results 126 generated in response to queries related to video playback.

From operation 314, the method 300 proceeds to operation 316, wherein the search engine 116 generates the advertising 130 for presentation with the search results 126. The search engine 116 can determine if advertising should be displayed with the applications 106, and if so, what type of advertising 130 should be presented. Similarly, entities or companies may pay to have advertising 130 corresponding to one or more applications 106 listed or advertised on search result pages corresponding to search results 126 for queries related to the applications 106.

From operation 316, the method 300 proceeds to operation 318, wherein the search engine 116 presents the ranked search results 126 and the advertising 130. The search results 126 can be presented in almost any desired format, based upon needs, requirements, and/or preferences. In some embodiments, the search results 126 are presented as a list of hits that correspond to the identified applications 106 and/or links thereto. The list of hits can be presented in a search results page or other format. In other embodiments, the identified applications 106 are presented in a web store format, wherein the applications 106 are provided with purchase options. A user may have an option to access a trial version of the application 106, to access or pay for a limited functionality version of the application 106, and/or to access or pay for the full functionality version of the application 106. Thus, the search engine 116 can present a number of options with each search result 126, if desired. Other presentation formats and methods are possible and are contemplated.

Similarly, the search engine 116 can determine how to present the advertising 130, if appropriate. The search engine 116 can determine not only the content of the advertising 130 to present with the search results 126, but also the position of the advertising, the format of the advertising, and a presentation method for the advertising 130. The advertising 130 may be presented as text, banner ads, popup windows, video, audio, popunder windows, new windows, links, sponsored links, and the like. As such, the search engine 116 can determine the layout of a screen for presenting the search results 126 and the advertising 130 before presenting the search results 126 and the advertising 130. The method 300 ends at operation 320.

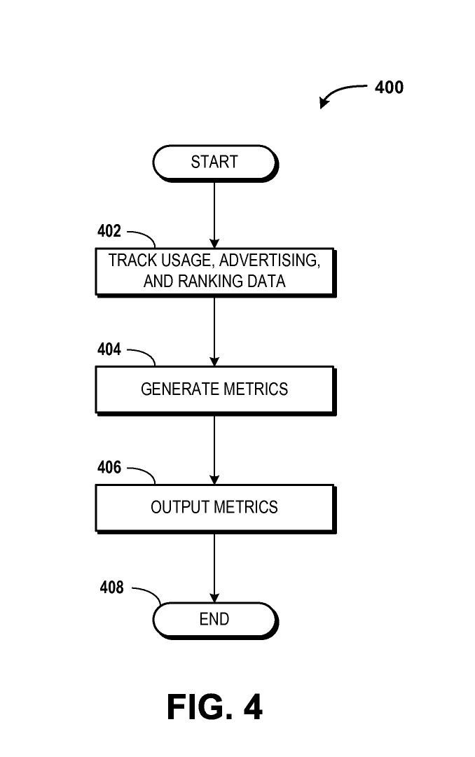

Turning now to FIG. 4, a method 400 for tracking and reporting application metrics is described in detail, according to an exemplary embodiment. For purposes of illustration, and not limitation, the method 400 is described as being performed by the search engine 116. It should be understood that he search engine 116 can provide the functionality described herein via execution of the analytics application 124 and/or other applications. As such, the described embodiment should be understood as being exemplary, and should not be construed as being limiting in any way.

As mentioned above, some embodiments of the search engine 116 and/or the client 132 support unified login and/or authentication. As such, the search engine 116 can be configured to track activity associated with the client 132, if authorized by a user of the client 132. Additionally, it should be appreciated that the search engine 116 can be configured to track activity associated with a particular user or other entity, across multiple client devices including, but not limited to, the client 132. In particular, as disclosed herein, the concepts and technologies disclosed herein support unified login and/or other authorization methods that can be used to associated activity at multiple devices with one or more entities. As such, the search engine 116 can be configured to track usage, preferences, and the like, associated with the one or more entities, including usage of applications 106, sub-features of applications, use of the search engine 116, and/or other activity. Furthermore, the search engine 116 can use data identifying what type of client device is used to access the search engine 116, applications 106, sub-features of applications, and the like, as contextual information for consideration with or inclusion in the contextual data 138. Thus, this contextual information also can be used for further refining queries 140 and/or search results 126.

In the embodiment illustrated in FIG. 4, it is assumed that the search engine 116 is configured to detect usage of an application 106 at the client 132, as well as other interactions at the client. For example, the search engine 116 may detect an interaction at the client 132 such as execution or access of an application 106, a click on a search result 126, a click on advertising 130, text entry at the client 132, and the like. The interaction detected by the search engine 116 also can include an interaction at the client 132 with one or more of the search results 126, an interaction at the client 132 with the advertising 130 provided with the search results 126, search activity associated with the client 132, as well as an interaction between the client 132 and one or more web-based or other remotely executed application 106 by the client 132. These interactions are exemplary. Other interactions are possible, and are contemplated, and any type of interaction at the client 132 and/or the search engine 116 can prompt or be subject to the functionality of the search engine 116 described below.

The method 400 begins with operation 402, wherein the search engine 116 tracks usage data, advertising data, and ranking data associated with the interaction at the client 132. The usage data tracked by the search engine 116 indicates usage of the application 106 at the client 132. More particularly, the usage data can indicate when the application 106 is used at the client 132, one or more identities or users associated with the use of the application 106 and the like. The usage data also can indicate other processes being executed at the client 132 when the application 106 is accessed or executed, search history associated with the client 132, geographic and/or network location of the client 132 used to access the application 106, demographic information associated with a user of the client 132 and/or a geographic location at which the application 106 is accessed, a time of day, week, month, or year at which the application 106 is accessed, combinations thereof, and the like. The usage data also can include a frequency with which the application 106 is accessed or executed, other applications 106 accessed by the client 132 for the same or similar functionality, versions of the application 106 used or accessed by the client 132, and the like. These examples of usage data are illustrative, and should not be construed as being limiting in any way.

The advertising data can indicate the types of advertising 130 presented to the client 132. As explained above with reference to FIG. 3, the advertising 130 can be generated by the search engine 116 in response to queries, the contextual data 138, and/or the SN data 114. In some embodiments, the search engine 116 stores data describing the generated advertising 130 upon generation. Additionally, the advertising data can indicate how the advertising 130 is displayed at the client 132, and/or how the client 132 interacted with the generated and/or presented advertising 130. The advertising data can indicate, for example, a number o clicks on a particular type of advertising 130. As such, an authorized entity associated with the advertising 130 may be able to more accurately determine the effectiveness of a particular marketing campaign and/or a particular type of advertising 130, as the number of clicks on a particular advertising 130 image may indicate how well the advertising 130 obtained the attention of a user of the client 132. These examples of advertising data are exemplary, and should not be construed as being limiting in any way.

The ranking data can indicate how applications 106 were ranked by the search engine 116. For example, in some embodiments, the applications 106 are ranked on the bases of relevance and/or popularity of the applications 106. Tracked data indicating this information may be valuable to an application developer as such information can indicate to the developer what terms or features of the application have affected the rank of the application.

The ranking data can indicate other ranking information that may be useful to an authorized party. For example, the number of times a particular application 106 is searched for by name or other identifying information such as URL, author, version number, and the like, can be logged by the search engine 116 and may be interpreted as indicating a relative popularity of the application 106. Additionally, the ranking data may indicate that other applications 106 are ranked higher than the application 106 because a competitor pays to have their application 106 ranked higher, and the like. Such information may be presented to an authorized party to generate upsell opportunities with the authorized party, e.g., by enticing the authorized party to purchase improved ranking and/or placement for their applications 106. These examples of ranking data are exemplary, and should not be construed as being limiting in any way.

From operation 402, the method 400 proceeds to operation 404, wherein the search engine 116 generates application metrics based upon the usage data, the advertising data, and/or the ranking data. In some embodiments, the usage data, advertising data, and/or ranking data are provided to an authorized party directly. In other embodiments, these and/or other data are summarized, and the summarized data are presented to an authorized entity such as an application developer. Although not illustrated in FIG. 4, it should be understood that the metrics can be reported in various formats appropriate for various systems or entities. As such, the data corresponding to the metrics may be exported into various formats prior to reporting the metrics to the appropriate party.

From operation 404, the method 400 proceeds to operation 406, wherein the search engine 116 provides the application metrics to the authorized entity. As explained above, users can be given the ability to opt-in or opt-out of the reporting of application metrics. As such, the generation and output of the application metrics can be subject to user approval before including any information relating to the user in the application metrics. The method 400 ends at operation 414.

According to various embodiments, the search engine 116 and/or one or more modules associated therewith uses the SN data 114 to support sharing features for the client 132. In some implementations, a user of the client 132 can activate videocasting of application usage 106 at the client 132. For example, the user of the client 132 may share his or her gaming activities with members of his or her social network as indicated by the SN data 114. The members of the social network may be able to access a first person or third person streaming video feed of activity of the user, if desired.

In other implementations, the user enables period screenshots of the application activity that are posted at regular or irregular intervals, and the like, streaming news tickers indicating activity at the client 132, and the like. In yet other implementations, the client 132 generates status updates for a social networking service or realtime messaging service, wherein the status updates or realtime messages indicate activity or application usage at the client 132. In some embodiments, a warning such as a banner or blinking indicator is activated at the client 132 when sharing is enabled to prevent accidental sharing of activity associated with the client 132.

Users can access this and other social networking functionality to determine what their social networking connections are doing, if such information is shared. In some embodiments, an option to “see what my friends are doing” is presented to a user at the client 132. In response to selection of this option, the client 132 retrieves, directly or via the search engine 116, the SN data 114, and is provided one or more streaming video windows, news tickers, audio files, updated screenshots, lists, and the like, wherein the multiple images, video, text, and/or audio correspond to the multiple connections associated with the user. As such, a user can simultaneously view some, all, or none of his or her social networking connections, and determine what kind of activities the social networking connections are involved with.

As mentioned above, the search engine 116 can be configured to check for application updates or to command other devices or network nodes to check for application updates. If an application 106 is updated, the search engine 116 can index and/or present one or both of the new version and the old version of the application 106. Thus, the search engine 116 can allow users to access one or more versions of the applications 106, according to users' preferences, system requirements, device capabilities and/or limitations, needs, and the like. The search engine 116 can check for updates for the applications 106 periodically or on-demand, and/or can be automatically informed when a new version of the application 106 released, thereby enabling the search engine 116 to quickly index and access the new version of the application 106.

According to some embodiments, the concepts and technologies disclosed herein also support versioning functionality for the applications 106. In particular, in some embodiments, application developers sell or make available limited-functionality versions of applications 106, which may be provided for free, for a nominal fee, and/or for a reduced fee relative to a full-functionality version of the application 106. In some embodiments, the contextual data 138 indicates that the user has the limited-functionality version of the application 106. The search engine 116 can be configured to suggest the full version of the application 106, for example, by returning a search result 126 corresponding to the full version of the application 106.

The search engine 116 can be configured to update the search index 128 when a new version of an application 106 is released or identified. In some instances, the search engine 116 replaces the existing version of the application 106 with the new version of the application 106. In other instances, the search engine 116 indexes the new version of the application 106 without removing the old version of the application from the search index 128, thereby allowing access to one or more versions of an application 106. If an application 106 or a version of an application 106 is no longer supported, or is determined by the search engine 116 or another device to be unreliable or superseded, the search engine 116 can remove data corresponding to the application 106 and/or the version of the application 106 from the search index 128.

In some embodiments, functionality and/or combinations of functionality associated with applications 106 can be searched, indexed, purchased, tested, installed, accessed, executed, and/or used in addition to, or instead of, full versions of the application 106. Thus, the search engine 116 may present functionality in the search results 126 in addition to applications 106. For example, if a search related to word processing is performed by the search engine 116, the search results 126 may include functionality that supplements a word processing application such as functionality for spell checking, translation, grammar checking, and the like, as well as word processing applications. This embodiment is exemplary, and should not be construed as being limiting in any way.

The search engine 116 also can be configured to track and report metrics relating to application 106 version and feature upgrades and/or downgrades. For example, a user may be informed that a new version of the application 106 is available. The new version of the application 106 may be installed after a purchase of the new version, automatically, by following a link, and the like. Such upgrades can be tracked, if desired. Similarly, downgrades can be tracked. More particularly, a user or other entity may upgrade to a new version of an application 106, an occurrence that may be tracked as explained above. At some time, the user or other entity may revert to an older version of the application 106 by uninstalling the new version of the application 106, accessing an old link for the application 106, explicitly selecting a downgrade option, and the like.

These downgrades can be tracked and reported to application developers or other authorized entities as such downgrades may indicate a problem with the new version of the application 106, a preference for the older version of the application 106, and the like. While a single downgrade may have little meaning, a trend of downgrades may indicate to the application developer or other entity that the new version of the application 106 has some issues that need to be corrected. As explained above with respect to new versions of the applications 106, the search engine 116 also can index and present application feature updates, notify users or other entities when such updates are available, track and report feature upgrades, and track and report feature downgrades.

According to some embodiments, a startup procedure for the client 132 includes a string of searches that are transmitted to the search engine 116. The searches are executed by the search engine 116 to identify updates for applications 106 used by the client 132. The string of searches can be kept current to reflect applications 106 used by or installed at the client 132, if desired.

As mentioned above, the search engine 116 and/or the client 132 support unified login functionality. According to various embodiments, a user logs into the client 132 and/or the search engine 116 with a single login. If desired, the single login can be used to authenticate the user with some, all, or no accessed applications 106. As mentioned above, some embodiments of the client 132 execute a web based OS. In some implementations of the web based OS, a user logs into the client 132 with a login, and the client 132 manages log in with the applications 106 and/or other entities during a user session. If a user opts-in to the application metric functionality described herein, the unified login can be used to associated activity at the client 132 with the user. This feature can be particularly useful in cloud computing scenarios, wherein more than one user may access an account or computing environment via logging into a shared computer. As such, the search engine 116 may be configured to differentiate between activity associated with a user and activity associated with a particular client 132 or other machine. Similarly, the search engine 116 may be configured to recognize activity across various machines as being associated with the same user, as explained above.

In some embodiments, one or more applications 106 are hosted under the control of a particular entity to allow the entity to restrict access to the applications 106, to manage the user experience with the applications 106, to ensure that sufficient computing and networking resources are available for the applications 106, to ensure privacy and security restrictions and policies with respect to the applications 106, and the like. In some embodiments, the same entity controls the search engine 116. As such, the tracking and metrics reporting disclosed herein can be simplified as the entity hosting the applications also hosts the search engine 116, thereby obviating communications between the client 132, the server computers 102, and/or the search engine 116. Additionally, or alternatively, the client 132 can execute a web OS that provisions the applications 106, services, and/or resources via the search engine 116, thereby allowing tracking of client 132 activity without requiring extensive communications between the client 132 and the search engine 116.

The search engine 116 also can recognize or maintain blacklists of applications 106. Applications 106 can be blacklisted on the basis of malicious activity, inaccurate or misleading descriptions, and the like. Access to the blacklisted applications 106, even if identified by the search engine 116 as satisfying a query 140, can be withheld from the client 132, blocked by the search engine 116, and/or otherwise restricted. Additionally, or alternatively, presence of blacklisted applications 106 in the search results 126 can prompt the search engine 116 to generate warnings or reports to the client 132, and the like. According to some embodiments, the search engine 116 is configured to access virus alerts and/or other sources to identify applications 106 associated with malicious activity. In some embodiments, inappropriate applications 106, applications 106 with inaccurate or misleading descriptions, and the like, can be reported to the search engine 116 via one or more interfaces or forms.

According to some embodiments, access to applications 106 can be restricted or improved based upon performance history, bandwidth limitations, subscription fees, and the like. For example, applications 106 may be indexed by the search engine 116 for free. While the applications 106 may be indexed for free, access to the applications 106 may be limited unless an entity associated with the applications 106 pays a premium. Methods for limiting access to the applications 106 include imposing limits upon a number of instances of an application 106 that are allowed to execute simultaneously or during a defined time period, a number of users who are allowed to access the application 106 during a defined time period, an amount of bandwidth dedicated to or available for supporting the application 106 or transfer of the application data 108, a number of times the application 106 is provided in the search results 126, and the like. These examples are illustrative, and should not be construed as being limiting in any way.

According to various embodiments, the search engine 116 or another device such as a billing/charging module or other software and/or hardware is configured to provide charging and or billing functionality. Thus, the search engine 116 can charge or bill users for accessing, downloading, and/or using the applications 106. According to some embodiments, the search engine 116 is configured to provide microcharge functionality associated with the applications 106. For example, if a user clicks on a link or advertising 130 associated with a particular application 106, the entity providing the search functionality and/or ranking and advertising functionality can track the click and generate a fee that is charged or billed to an entity associated with the link or the advertising 130. In some embodiments, the charge is a microcharge generated per click on a search result 126 or advertising 130, per display of the advertising 130, and the like. The microcharge can include, for example, a charge on the order of portions of a cent, cents, and/or dollars. The microcharges can be tracked and billed according to any desired schedules and/or intervals, if desired.

In some embodiments, applications 106 can be placed on a gift registry or wish list. Thus, the applications 106 can be purchased for others and/or gifted, if desired. Additionally, the search engine 116 can tailor purchasing options based upon tracked or known information relative to a client 132, if desired. For example, price points can be moved based upon the purchaser. For example, an application developer may authorize a certain number of sales at a reduced price. The search engine 116 can offer the reduced price to particular users based upon purchasing trends, usage history, and the like, which may be known by the search engine 116.

Similarly, the search engine 116 can tailor presentation of the applications 106 and/or purchasing options based upon purchasing information. If, for example, a user of the client 132 has an established trend of paying no more than $5 for applications 106, the search engine 116 may present applications 106 below the $5 price point first, even if other applications 106 are believed to be more relevant to the user based upon a received query 140, the SN data 114, and/or the contextual data 138. Additionally, application developers may set automatic and/or incremental price increases or decreases based upon purchase activity. Thus, when popularity of an application 106 begins trending upward, an automatic price increase or decrease may be applied to the application 106. Other methods of shifting price based upon users, purchasing trends, popularity, and relevance are possible and are contemplated. Thus, the above examples should be viewed as illustrative, and not limiting in any way.

In some embodiments, the billing and charging functionality is used to provide various pay-as-you-go applications 106. For example, a periodical application 106 may be free, but a user may be required to pay for articles. In some embodiments, portions of the periodical may be one price, or may be free, while other portions such as features or other articles may require payment of a charge and/or a higher price. The generation and placement of advertising 130 in periodical applications 106 can be managed by the search engine 116 and may take into account activity occurring at the client 132 or elsewhere, if desired.

In the various embodiments disclosed herein, the tracking and reporting of metrics have been discussed. It should be stressed that all tracking and reporting of metrics associated with the applications 106 and/or the client 132 can be subject to users opting in and/or otherwise authorizing this functionality. Similarly, the users can opt-out or deactivate the tracking and reporting functionality at any time. Also, it should be understood that all information tracked and/or reported can be anonymized prior to storage and/or reporting. These and other security and/or privacy measures can be taken to address perceived privacy and/or security considerations.

In some embodiments, the client 132 executes some aspects of the application 106, while other aspects of the application 106 can be executed remotely. The client 132 can be configured to synchronize data computed at the client 132 with the device hosting or executing the application 106 remotely such as, for example, the server computer 102. In some embodiments, the client 132 is further configured to transmit data to the device hosting or executing the application 106 with information that identifies what computations were completed at the client 132, if desired.

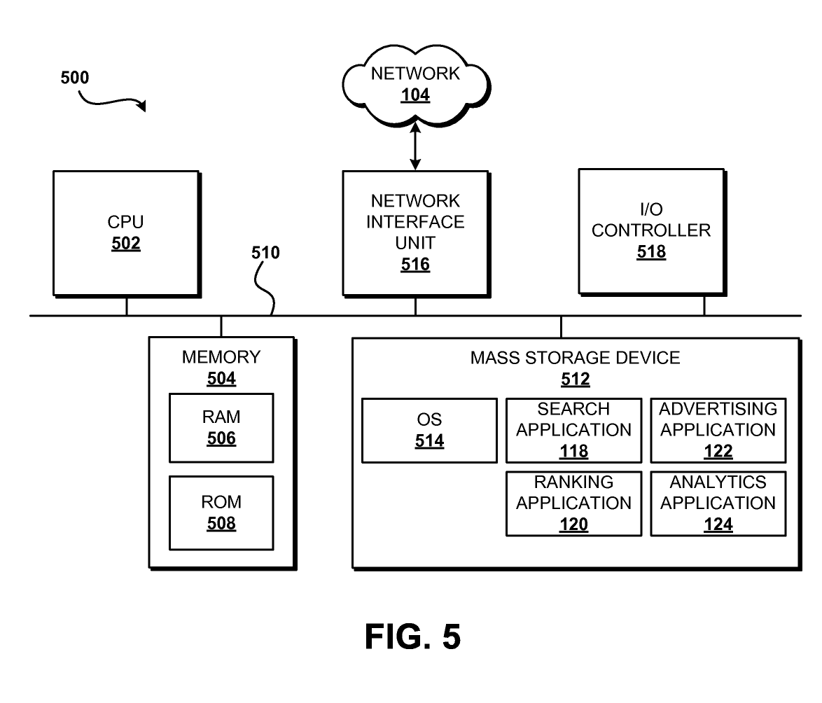

FIG. 5 illustrates an exemplary computer architecture 500 for a device capable of executing the software components described herein for discovery of remotely executed applications 106. Thus, the computer architecture 500 illustrated in FIG. 5 illustrates an architecture for a server computer, mobile phone, a PDA, a smart phone, a server computer, a desktop computer, a netbook computer, a tablet computer, and/or a laptop computer, for example the search engine 116. The computer architecture 500 may be utilized to execute any aspects of the software components presented herein.

The computer architecture 500 illustrated in FIG. 5 includes a central processing unit 502 (“CPU”), a system memory 504, including a random access memory 506 (“RAM”) and a read-only memory (“ROM”) 508, and a system bus 510 that couples the memory 504 to the CPU 502. A basic input/output system containing the basic routines that help to transfer information between elements within the computer architecture 500, such as during startup, is stored in the ROM 508. The computer architecture 500 further includes a mass storage device 512 for storing an operating system 514, the search application 118, the ranking application 120, the advertising application 122, and the analytics application 124. Although not illustrated in FIG. 5, it should be understood that the mass storage device 512 can store the search index 128 and/or other data (not illustrated).

The mass storage device 512 is connected to the CPU 502 through a mass storage controller (not shown) connected to the bus 510. The mass storage device 512 and its associated computer-readable media provide non-volatile storage for the computer architecture 500. Although the description of computer-readable media contained herein refers to a mass storage device, such as a hard disk or CD-ROM drive, it should be appreciated by those skilled in the art that computer-readable media can be any available computer storage media that can be accessed by the computer architecture 500.

By way of example, and not limitation, computer-readable storage media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 500. For purposes of this specification and the claims, the phrase “computer-readable storage medium” and variations thereof, does not include communication media.

According to various embodiments, the computer architecture 500 may operate in a networked environment using logical connections to remote computers through a network such as the network 104. The computer architecture 500 may connect to the network 104 through a network interface unit 516 connected to the bus 510. It should be appreciated that the network interface unit 516 also may be utilized to connect to other types of networks and remote computer systems, for example, the client device 132. The computer architecture 500 also may include an input/output controller 518 for receiving and processing input from a number of other devices, including a keyboard, mouse, or electronic stylus (not shown in FIG. 5). Similarly, the input/output controller 518 may provide output to a display screen, a printer, or other type of output device (also not shown in FIG. 5).

It should be appreciated that the software components described herein may, when loaded into the CPU 502 and executed, transform the CPU 502 and the overall computer architecture 500 from a general-purpose computing system into a special-purpose computing system customized to facilitate the functionality presented herein. The CPU 502 may be constructed from any number of transistors or other discrete circuit elements, which may individually or collectively assume any number of states. More specifically, the CPU 502 may operate as a finite-state machine, in response to executable instructions contained within the software modules disclosed herein. These computer-executable instructions may transform the CPU 502 by specifying how the CPU 502 transitions between states, thereby transforming the transistors or other discrete hardware elements constituting the CPU 502.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 500 in order to store and execute the software components presented herein. It also should be appreciated that the computer architecture 500 may include other types of computing devices, including hand-held computers, embedded computer systems, personal digital assistants, and other types of computing devices known to those skilled in the art. It is also contemplated that the computer architecture 500 may not include all of the components shown in FIG. 5, may include other components that are not explicitly shown in FIG. 5, or may utilize an architecture completely different than that shown in FIG. 5.

Based on the foregoing, it should be appreciated that technologies for discovery of remotely executed applications 106 have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

We claim:

1. A computer-implemented method for searching for a web application, the computer-implemented method comprising performing computer-implemented operations for:
receiving a query at a search engine;
executing the query at the search engine to identify one or more web applications that satisfy the query, the web applications comprising one or more sub-features of the web applications;
generating search results corresponding to the one or more web applications; and
making the search results available for presentation at a client in communication with the search engine, the search results comprising data identifying the one or more web applications, data identifying a location associated with the one or more web applications, and data for presentation of the search results in a web store viewable at the client.

2. The method of claim 1, further comprising:
determining if contextual data associated with the client is available, the contextual data indicating one or more interactions occurring at the client;
in response to determining that the contextual data is available, obtaining the contextual data; and
modifying the query to reflect the contextual data.

3. The method of claim 2, further comprising:
determining if social networking data corresponding to a user of the client is available, the social networking data comprising information indicating a web application accessed by a member of a social network;
in response to determining that the social networking data is available, obtaining the social networking data; and
modifying the query to reflect the social networking data.

4. The method of claim 1, further comprising:
ranking the web applications; and
presenting the search results in accordance with the ranking of the web applications.

5. The method of claim 3, further comprising:
ranking the web applications based, at least partially, upon the social networking data; and
presenting the search results in accordance with the ranking of the web applications.

6. The method of claim 1, further comprising:
generating advertising for presentation with the search results; and
presenting the advertising with the search results.

7. The method of claim 1, wherein executing the query comprises accessing a search index to identify the web applications.

8. The method of claim 7, further comprising:
identifying one or more applications during a search for web applications generating data describing the web applications;
organizing the data describing the web applications based upon one or more application characteristics associated with the web applications; and
storing the data describing the web applications in the search index, the data describing the web applications being stored in the search index in a searchable format.

9. The method of claim 1, further comprising:
tracking data reflecting activity at the client;
generating metrics related to the activity at the client; and
reporting the metrics to at least one authorized entity.

10. The method of claim 9, wherein the tracked data comprises
usage data comprising information describing usage of the web application associated with the client,
advertising data comprising information describing advertising presented with the search results, and
ranking data comprising information describing how the search results are ranked.

11. A computer-implemented method for using a web application, the computer-implemented method comprising performing computer-implemented operations for:
submitting a query to a search engine in communication with a client, the search engine being configured to execute the query to identify one or more web applications that satisfy the query and to generate search results corresponding to the one or more web applications, the web applications comprising one or more sub-features of the web applications;
receiving the search results from the search engine, the search results comprising data identifying the one or more web applications and data identifying a location associated with the one or more web applications;
receiving, at the client, a selection of one of the search results; and
accessing a web application corresponding to the selected search result, in response to receiving the selection.

12. The method of claim 11, further comprising making contextual data associated with the client available to the search engine for modifying the query based, at least partially, upon the contextual data, the contextual data indicating one or more interactions occurring at the client.

13. The method of claim 12, wherein the search results received from the search engine are based, at least partially, upon social networking data corresponding to a user of the client, and wherein the search results received from the search engine are based upon a modified query, the modified query being based, at least partially, upon the social networking data.

14. The method of claim 13, further comprising receiving advertising from the search engine, the advertising being generated by the search engine based, at least partially, upon the contextual data or the social networking data.

15. The method of claim 11, wherein the search results received from the search engine are based, at least partially, upon data stored in a search index, and wherein the search index is generated by:
identifying one or more web applications during a search for applications generating data describing the web applications;
organizing the data describing the web applications based upon one or more application characteristics associated with the web applications; and
storing the data describing the web applications in the search index, the data describing the web applications being stored in the search index in a searchable format.

16. The method of claim 11, further comprising:
executing a web-based operating system configured to access the web applications;
receiving application data and rendering the application data at the client;
tracking data reflecting activity at occurring at the client;
generating metrics related to the activity at the client; and
reporting the metrics to at least one authorized entity.

17. The method of claim 16, wherein the data tracked comprises
usage data comprising information describing usage of the web application associated with the client,
advertising data comprising information describing advertising presented with the search results, and
ranking data comprising information describing how the search results are ranked.

18. A computer-readable storage medium having computer readable instructions stored thereupon that, when executed by a computer, cause the computer to:
receive a query at a search engine, the query being received from a client in communication with the search engine;
determine if contextual data associated with the client is available, the contextual data indicating one or more interactions occurring at the client;
in response to determining that the contextual data is available, obtain the contextual data;
determine if social networking data corresponding to a user of the client is available, the social networking data comprising information indicating one or more web applications accessed by a member of a social network associated with the user of the client;
in response to determining that the social networking data is available, obtain the social networking data;
modify the query to reflect the contextual data and the social networking data;
execute the modified query at the search engine to identify one or more web applications that satisfy the modified query;
generate search results corresponding to the one or more web applications, the search results comprising data identifying the one or more web applications and data identifying a location associated with the one or more web applications; and
transmit the search results to the client for presentation at the client.

19. The computer-readable storage medium of claim 18, further comprising instructions that, when executed by the computer, cause the computer to:
rank the web applications based, at least partially, upon one or more terms of the query, the contextual data, and the social networking data;
generate advertising for presentation with the search results; and
present the advertising with the search results, the search results being presented in an order based, at least partially, upon the ranking of the web applications.

20. The computer-readable storage medium of claim 19, further comprising instructions that, when executed by the computer, cause the computer to:
track data reflecting an interaction between the client and a server computer hosting the web application;
generate metrics related to the interaction between the client and the server computer; and
report the metrics to an application developer associated with the web application accessed by the client.
